(19) United States
(12) Patent Application Publication
(10) Pub. No.: US 2023/0196250 A1
(43) Pub. Date: Jun. 22, 2023

(54) AUTOMATIC ALTERNATIVE ROUTE GENERATION

(71) Applicant: International Business Machines Corporation, Armonk, NY (US)

(72) Inventors: Herbert Scott McFaddin, Yorktown Heights, NY (US); Youssef Drissi, Peekskill, NY (US); Markus Ettl, Yorktown Heights, NY (US); Anna Lisa Gentile, San Jose, CA (US); Petar Ristoski, San Jose, CA (US)

(21) Appl. No.: 17/557,784

(22) Filed: Dec. 21, 2021

(51) Int. Cl. G06Q 10/06

(52) U.S. Cl. CPC G06Q 10/06393

(57) ABSTRACT

A processor may receive travel information and user travel query. The user travel query may be from a user. A processor may analyze the travel information and the user travel query. A processor may generate one or more operational condition predictions from the travel information and user query. A processor may generate one or more passenger satisfaction predictions from the travel information and user query. A processor may identify a user satisfaction score based, at least in part, on one or more feature variances. The one or more feature variances may be based, at least in part on the one or more operational condition predictions and the one or more passenger satisfaction predictions. A processor may output the user satisfaction score to the user.

### BACKGROUND

The present disclosure relates generally to the field of artificial intelligence (AI), and more particularly to making travel plans.

The development of AI related technology has changed how people interact with their environment. As this technology has grown in popularity, so too has demand to make AI more available to users for daily use. This demand has resulted in AI technology has been adopted across industries to address various business needs.

### SUMMARY

Embodiments of the present disclosure include a method, computer program product, and system for ranking journey plans. A processor may receive travel information and user travel query. The user travel query may be from a user. A processor may analyze the travel information and the user travel query. A processor may generate one or more operational condition predictions from the travel information and user query. A processor may generate one or more passenger satisfaction predictions from the travel information and user query. A processor may identify a user satisfaction score based, at least in part, on one or more feature variances. The one or more feature variances may be based, at least in part on the one or more operational condition predictions and the one or more passenger satisfaction predictions. A processor may output the user satisfaction score to the user.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of a journey ranking system, in accordance with the present disclosure.

FIG. 2 depicts a block diagram of an embodiment of a journey ranking system, in accordance with the present disclosure.

FIG. 3A flowchart of journey ranking system, in accordance with embodiments of the present disclosure.

FIG. 3B depicts a continuation of the process of the journey ranking system, in accordance with embodiments of the present disclosure.

FIG. 3C depicts another continuation of the process of the journey ranking system, in accordance with embodiments of the present disclosure.

FIG. 4 illustrates a flowchart of a method for ranking journey plans, in accordance with embodiments of the present disclosure.

FIG. 5A illustrates a cloud computing environment, in accordance with embodiments of the present disclosure.

FIG. 5B illustrates abstraction model layers, in accordance with embodiments of the present disclosure.

FIG. 6 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence (AI), and more particularly to ensuring customer satisfaction using AI in industries, such as the airline or travel industry. While the present disclosure is not necessarily limited to such applications, various aspects of the disclosure may be appreciated through a discussion of various examples using this context.

In the travel industry, travel operators (e.g., airlines) are increasingly focused on customer (e.g., user) satisfaction as a key performance indicator (KPI), particularly as it relates to the airline travel industry. Generally, though broadly, there are three broad opportunities where customer satisfaction, early, middle and late intervention. Early intervention may occur when the customer is making plans and reservations. During this time, the travel operator can steer the customer away from travel flight plans that have the potential to reduce customer satisfaction (e.g., delayed or cancelled flight plan). Middle interventions may occur while the customer is actually traveling. During this time, the travel operator can attempt to minimize the likelihood of a customer experiencing negative travel situations, such as rescheduling a missed connecting flight that does not delay the customer's overall travel plans. Middle intervention is often the most difficult for travel operators. Late intervention occurs after the customer has travelled. Late intervention generally includes travel operators attempting to improve a customer's satisfaction after receiving a complaint by making one or more types of compensations. For example, a travel operator may offer a significantly discounted or free trip (e.g., free transportation) to make up for a customer's cancelled trip. While late intervention may be the easiest to implement, often such methods are expensive.

Late intervention is often the last resort for travel operators to improve customer satisfaction (e.g., user satisfaction score) after a customer has already experienced a travel issue resulting from failed operational parameters. As can be expected, once a customer has had a negative experience, rectifying and improving their experience can result in a significant cost to the travel operators. In the aggregate, travel operators and their associated industry often spend millions of dollars on customer compensations and ameliorations.

Generally, customers (e.g., users) make several key travel choices at the time they make a travel reservation. In situations where a customer is attempting to choose a flight plan to a particular destination, they are presented with few options that have minimal differentiation. These options usually include the departure and arrival times for a particular flight (e.g., takeoff, landing, and connecting flight times) and the various prices associated with each of the offered flights. These few travel options provide little information regarding possible travel situations that may negatively affect a user's (e.g., customer's) travel experience. In many situations, there would be a substantial monetary savings for such industries and the associated travel operators if there was a solution that steered customers away from travel situations likely to result in the customer's decreased satisfaction and resulting complaints. As such, there is a desire to provide more tools that allow users to avoid travel experiences that may result in customer dissatisfaction (e.g., a low user satisfaction score).

Before turning to the FIGS. it is noted that the benefits/novelties and intricacies of the proposed solution are that:

A processor may annotate travel choices with planned journey features (e.g., planned departure times, planned connecting airports) and operational features (e.g., planned taxi times).

A processor may augment planned features with operational variances (e.g., weather). In some embodiments, a processor may augment such planned features using historical data (e.g., AI and/or machine learning capabilities). Such operational variances may be substantially different depending on the journey choices. For example, one connecting airport may tend to have seasonal weather effects for particular travel data selected by the user.

A processor may add the operational variances to the planned features to generate a set of test journeys. In such embodiments, the processor may generate a weighted probability for each test journey. The weighted probability for each test journey may be used by the processor to generate a test satisfaction score. The test satisfaction scores and probability weights can be merged by the processor to generate a user satisfaction score associated with a particular journey. The processor may identify one or more particular journeys with the highest user satisfaction scores and report those journeys to the user.

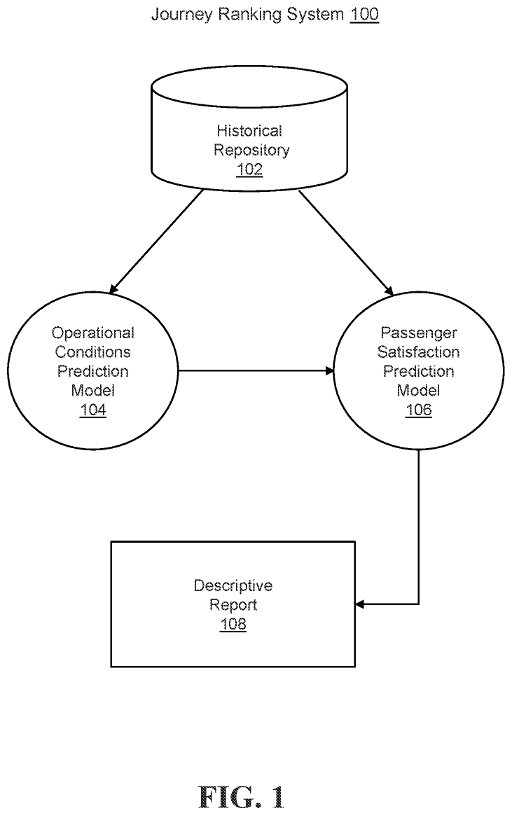

Referring now to FIG. 1, a block diagram of journey ranking system 100 for ranking journey plans alternatives based on predicted passenger and flight features is depicted, in accordance with embodiments of the present disclosure. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

In embodiments, journey ranking system 100 may be configured to include historical repository 102, operational conditions prediction model 104, user satisfaction prediction model 106, and descriptive report 108. Journey ranking system 100 may be configured to receive a user travel query (e.g., desired flight plan) regarding a particular journey the user would like to purchase. In embodiments, historical registry 102 may be configured to store travel information. Travel information may include historical operation and complaint data associated with users (e.g., passenger complaints and/or passenger satisfaction) and various flight operation data. This data may be collected/received from one or more data collection devices over time.

In embodiments, journey ranking system 100 may be configured to analyze travel information and the user travel query using AI and machine learning capabilities. In such embodiments, journey ranking system 100 may be configured to generate a first AI model, operational conditions prediction model 104, and a second AI model, user satisfaction prediction model 106, using travel information stored in historical repository 102. In embodiments, operational conditions prediction model 104 may be trained (e.g., using travel information, such as weather and flight features) to generating one or more operational condition predictions, based on the travel information (e.g., target passenger variables which measure customer satisfaction, such as complaint counts) and the user travel query. The one or more operational condition predictions may include features such as flight arrival time, likely inbound and outbound flight delays, and taxiing times. User satisfaction prediction model 106 may be trained to generate one or more passenger satisfaction predictions based on, travel information and user query.

Using the information/data generated by operational conditions prediction model 104 and user satisfaction prediction model 106, journey ranking system 100 may be configured to identify one or more user satisfaction scores. The user satisfaction score may indicate to the user the predicted level of satisfaction the user is likely to have regarding a particular journey (e.g., flight plan). User satisfaction scores may range from high to low. A high user satisfaction score may indicate that the user is likely to be satisfied with a particular journey plan (e.g., based on the user's user travel query) while a low user satisfaction score likely indicates the user is unlikely to be satisfied and may have one or more complaints regarding the particular journey plan. In one example embodiment, a user may provide journey ranking system 100 with user travel queries indicating “which of the departing flights are likely to be delayed,” “which of the following layovers is likely to be extended,” and “which of the connecting hubs are likely to have afternoon thunderstorms in late May, that may result in the flight being delayed.” Based on the associated user satisfaction scores, journey ranking system 100 may indicate (e.g., in descriptive report 108) that of the possible journey plans (e.g., flight plans) there is an equal likelihood that all flights may be affected the same (e.g., all flight plans have the same likelihood of being delayed), identify a particular journey plan that may be affected (e.g., the layover associated with a particular flight plan is more likely to be extended) but if selected by the user will likely experience a positive effect (e.g., high customer/user satisfaction score), and/or identify a particular journey plan that may be affected (e.g., a particular flight plan may be more likely to be delayed based on inclement weather during particular times of the year) and if selected the user will likely experience a negative effect (e.g., low customer/user satisfaction score).

In embodiments, the user satisfaction score may be based, at least in part, on one or more feature variances (e.g., operational variances, external force variances, market forces variance). The feature variances may be understood as the features that were used by operational conditions prediction model 104 and user satisfaction prediction model 106 and determined to be most influential in reaching the one or more user satisfaction scores (e.g., feature variances having a high probability level of occurrences) associated with the user travel query. In embodiments, journey ranking system 100 may be configured to present (e.g., output) the user satisfaction score or scores to the user in descriptive report 108. Descriptive report 108 may include an explanation of the score and relevant predictions. In some embodiments, journey ranking system 100 may generate an aggregate expect user satisfaction score that includes a plurality of computed user satisfaction scores (e.g., based on the available journey plans). While in some embodiments, descriptive report 108 may include an aggregate expected user satisfaction score, in other embodiments, descriptive report 108 may only include the journey plans having the highest user satisfaction scores.

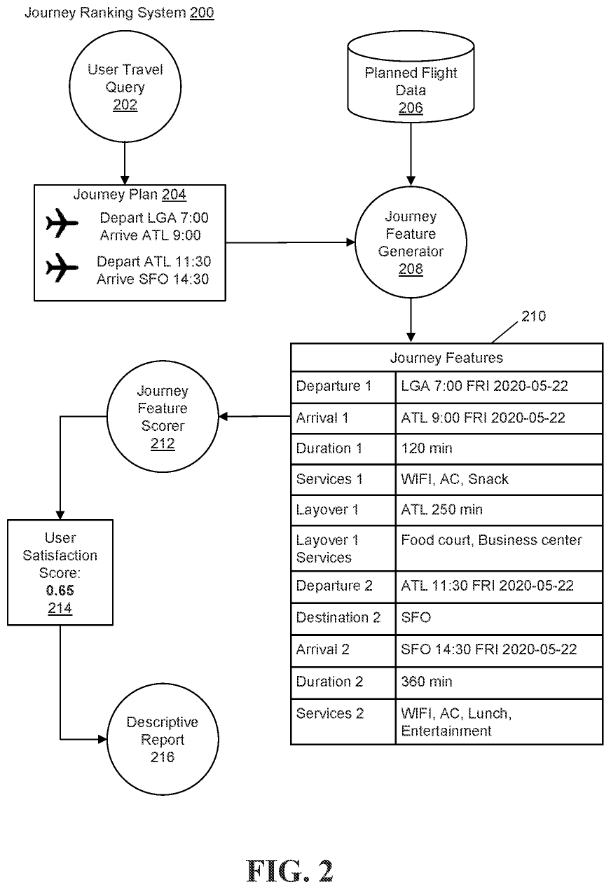

Turning to now to FIG. 2, a block diagram of flight ranking system 200 for ranking journey plans based on predicted passenger and flight features is depicted, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

Journey ranking system 200 may be understood to be a more detailed example of journey ranking system 100 depicted in FIG. 1. Journey ranking system 200 may be configured to provide example embodiments regarding include some or all of the components contemplated in regards to journey ranking system 100. In embodiments, journey ranking system 200 may receive user travel query 202 (e.g., using a reservation advisor) regarding proposed journey plan 204. Journey ranking system 200 may also be configured to receive planned flight data (e.g., travel information), such as that stored in the historical repository (e.g., historical repository 102). In embodiments, journey ranking system 200 may analyze this information (e.g., travel information and user travel query) using journey feature generator 208 (e.g., using operational conditions prediction model 104 and user satisfaction prediction model 106). Journey feature generator 208 may generate one or more journey features 210, such as those example features depicted in the journey feature table in FIG. 2. Journey ranking system 200 may include journey feature scorer 212. Journey feature scorer 212 may analyze the generated journey features 210 and may determine user satisfaction score 214 (e.g., the determined user satisfaction score is 0.65). Journey ranking system 200 may then present the user with descriptive report 216. Descriptive report 216 may include user satisfaction score 214 and/or any other information that may be used to predict or determine user satisfaction score 214. In some embodiments, descriptive report 216 may be presented to the user using a reservation advisor, such as an interactive website.

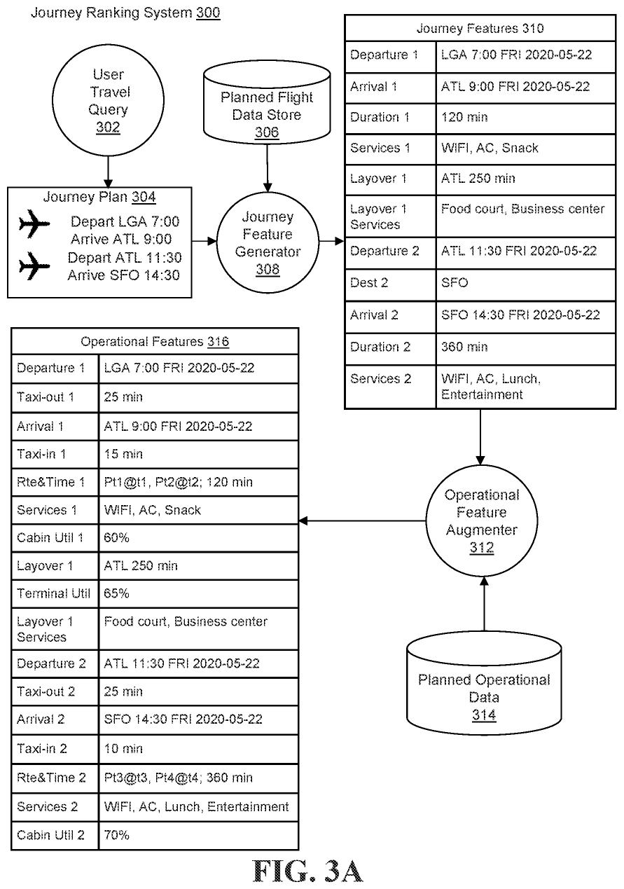

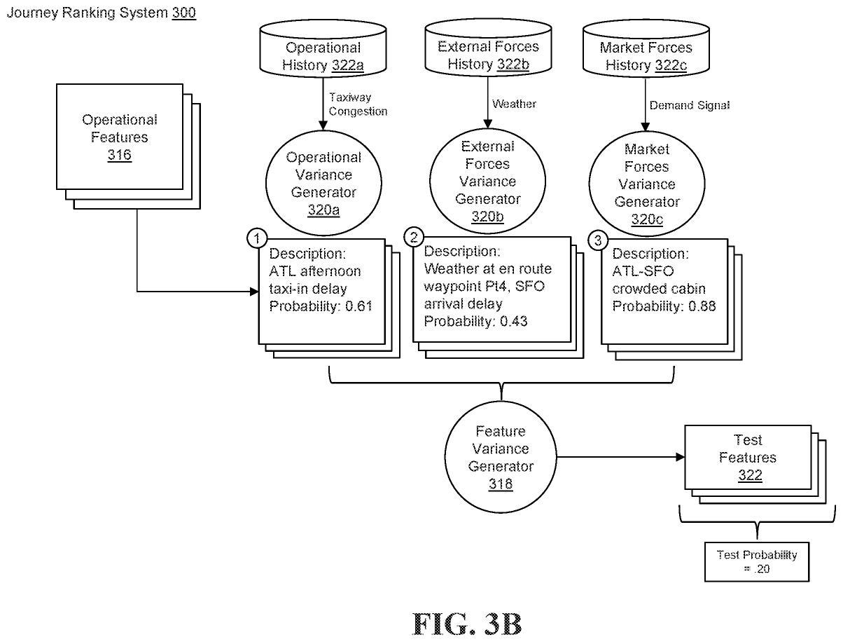

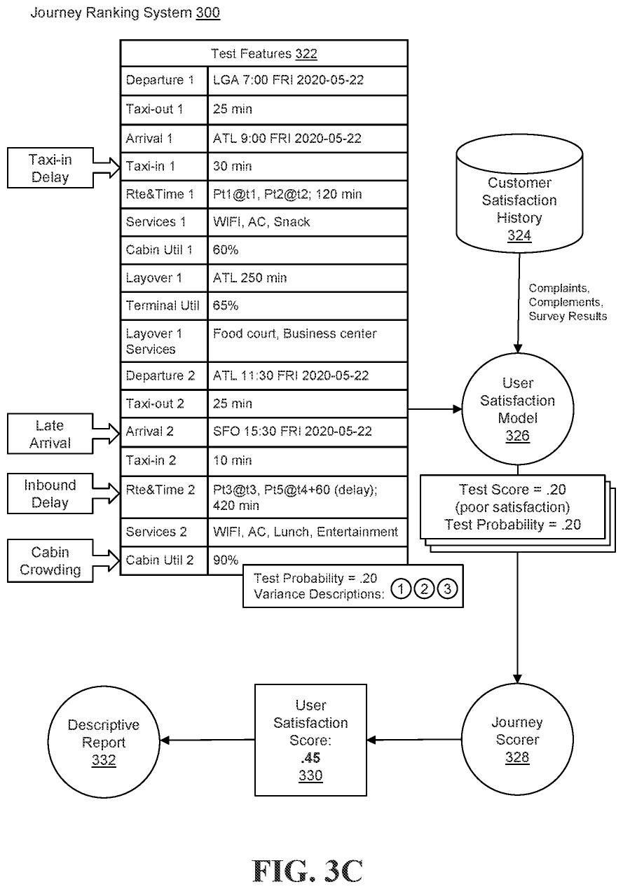

Turning to now to FIGS. 3A-3C, a block diagram of flight ranking system 300 for ranking journey plans based on predicted passenger and flight features is depicted, in accordance with embodiments of the present disclosure. FIGS. 3A-3C provides an illustration of only one implementation and does not imply any limitations with regard to the environments in which different embodiments may be implemented. Many modifications to the depicted environment may be made by those skilled in the art without departing from the scope of the invention as recited by the claims.

Journey ranking system 300 may be understood to be a more detailed example of journey ranking system 100 depicted in FIG. 1. Journey ranking system 300 may be configured to provide example embodiments regarding include some or all of the components contemplated in regards to journey ranking system 100. In embodiments, journey ranking system 300 may receive user travel query 302 (e.g., using a reservation advisor) regarding proposed journey plan 304. The user travel query may include an ordered sequence of segment descriptions. In embodiments, each segment description may each include, but is not limited to a travel date and time, an origin travel point code, a destination travel point code, a carrier code and a service number. Journey ranking system 300 may also be configured to receive planned flight data (e.g., travel information), such as that stored in the historical repository (e.g., historical repository 102). In embodiments, journey ranking system 300 may analyze this information (e.g., travel information and user travel query) using journey feature generator 308 (e.g., using operational conditions prediction model 104).

In embodiments, journey ranking system 300 may be configured to augment the journey description (e.g., journey plan based on the user travel query) with planned features of each segment description (e.g., using operational conditions prediction model 104). Augmenting the journey descriptions may be based on planned features data (e.g., travel information stored in the historical repository). The planned features may include a set of services (e.g., types of services provided on the flight) and amenities available during the segment. In some embodiments, journey raking system 300 may further augment the journey description (e.g., user travel query) with an ordered sequence of connection features. Each connection feature may include a connecting travel point between each ordered segment and additional connection features. This may be based on a planned features (e.g., travel information) stored in the historical repository and additional connection features. Additional connection resources may include a list of services, such as those available at the connection point during the layover period. Journey feature generator 308 may generate one or more journey features 310, such as those example features depicted in the journey feature table in FIG. 3A.

In embodiments, journey ranking system 300 may include operational feature augmenter 312. Operational feature augmenter 312 may receive the generated journey features 310 and planned operational data 314 (e.g., travel information) that may be stored in the historical repository. In embodiments, operational feature augmenter 312 may augment the journey description (e.g., data associated with journey plan 304 user travel query 302) with a set of operational features 316 (e.g., planned operational features). The operational features 316 may include, but are not limited to a planned taxi-out or staging time, a planned taxi-in, de-staging time, a planned travel route, a planned travel route duration, or a combination thereof. Examples of operational features 316, such as augmented by operational feature augmenter 312, are depicted in FIG. 3A.

Turning now to FIG. 3B, journey ranking system 300 may take the operational features 316 (e.g., previously discussed in reference to FIG. 3A) and generate one or more feature variances. Feature variance generator 318 may include one or more sub-generators, such as operational variance generator 320a, external forces variance generator 320b, and market forces variance generator 320c. In embodiments, feature variance generator 318 (e.g., using operational variance generator 320a) may generate one or more operational feature variances using operational historical data (e.g., travel information). These one or more operational feature variances may be associated with or match the augmented journey description. The operational feature variances may include an estimated change in value for a journey feature, an estimated probability of occurrence of that change in value, and a description of the change in value. In some embodiments, the feature variance generator 318 may base the operational feature variances on available operational history and the correlations to changes in matching journey features (e.g., travel information stored in historical repository 102).

In embodiments, feature variance generator 318 (e.g., using external forces variance generator 320b) may generate one or more external force feature variances using external forces historical data (e.g., travel information). These one or more external force feature variances may match the augmented journey description. The external force feature variances may include an estimated change in value for a journey feature, an estimated probability of occurrence of that change in value, and a description of the change in value. In some embodiments, the feature variance generator 318 may base the external forces feature variances on available external forces history and the correlations to changes in matching journey features (e.g., travel information stored in historical repository 102).

In embodiments, feature variance generator 318 (e.g., using market forces variance generator 320c) may generate one or more market force feature variances using market force historical data (e.g., travel information). These one or more market force feature variances may match the augmented journey description. The external force feature variances may include an estimated change in value for a journey feature, an estimated probability of occurrence of that change in value, and a description of the change in value. In some embodiments, the feature variance generator 318 may base the market forces feature variances on available market forces history and the correlations to changes in journey features (e.g., travel information stored in historical repository 102). In embodiments, feature variance generator 318 may use the aforementioned generated feature variances to generate test features 322. The test features 322 may include a plurality of combinations of the previously generated operational feature variances, external forces feature variances, and market forces feature variances.

Turning now to FIG. 3C, journey ranking system 300 may analyze test features 322 (e.g., previously discussed in reference to FIG. 3B) and customer satisfaction history (e.g., travel information from historical repository 102) using user satisfaction model 326 (e.g., user satisfaction prediction model 106). In embodiments, journey ranking system 300 may be configured to apply some or all of the provided test features 322 to the augmented journey description (e.g., user travel query 302). In such embodiments, each application of the test feature may produce/generate a test journey feature record. The test journey feature record may be further augmented using the probability of occurrence of a particular test feature among all of the generated test features 322. In some embodiments, the test journey feature record may also be augmented with the descriptions of the journey feature variances.

In embodiments, journey ranking system 300 may be configured to compute a user satisfaction score 330 using journey scorer 328. In embodiments, journey scorer 328 may be configured to produce a user satisfaction score 330 for each test journey feature record generated. The journey scorer 328 may base the computation of the user satisfaction score 330 on historical customer satisfaction measurements associated with historical journey feature records (e.g., travel information stored in the historical repository). In some embodiments, journey ranking system 300 may be configured to analyze user satisfaction scores 330 and the test journey feature records to compute an aggregated expected user satisfaction score 330. In these embodiments, the aggregated expected customer satisfaction score may be used to generate descriptive report 332. In embodiments, descriptive report 322 may include a reporting of the various scores contemplated herein and a description of how each score was identified with relevant information. In some embodiments, journey ranking system 300 may issue the descriptive report 332 to a reservation advisor (e.g., travel reservation advisory systems). In some embodiments, journey ranking system 100 may configure descriptive report 332 to be presented to a user in such a way that enables the user to consider one or more journey plans while making travel decisions. In some embodiments, the granularity of generated feature variances may be determined by a configurable search parameter and step size. In some embodiments the provided test set of journey feature variances is based upon a parameterized selection of journey feature variances that have the highest probability of occurrence.

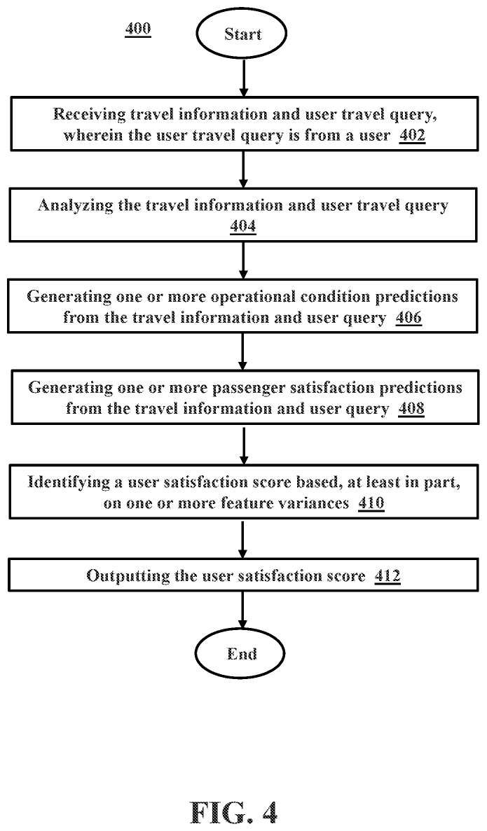

Referring now to FIG. 4, a flowchart illustrating an example method 400, in accordance with embodiments of the present disclosure. FIG. 4 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 400 begins at operation 402 where a processor may receive travel information and user travel query. In some embodiments, the user travel query may be derived from a user interacting with a reservation advisor. In some embodiments, the method 400 proceeds to operation 404.

At operation 404, a processor may analyze the travel information and the user travel query. In some embodiments, the method 400 proceeds to operation 406.

At operation 406, a processor may generate one or more operational condition predictions from the travel information and user query. In some embodiments, the method 400 proceeds to operation 408.

At operation 408, a processor may generate one or more passenger satisfaction predictions from the travel information and user query. In some embodiments, the method 400 proceeds to operation 410.

At operation 410, a processor may identify a user satisfaction score based, at least in part, on one or more feature variances. In some embodiments, the one or more feature variances may be based, at least in part on the one or more operational condition predictions and the one or more passenger satisfaction predictions. In some embodiments, the method 400 proceeds to operation 412.

At operation 412, a processor may output the user satisfaction score. In some embodiments, the processor may output the user satisfaction score to a user in a descriptive report and/or to a reservation advisor. In some embodiments, as depicted in FIG. 4, after operation 408, the method 400 may end.

As discussed in more detail herein, it is contemplated that some or all of the operations of the method 400 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

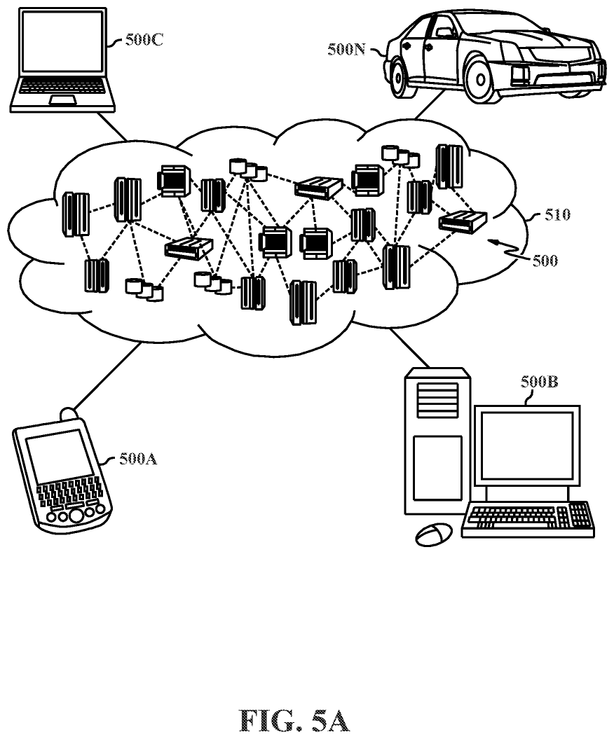

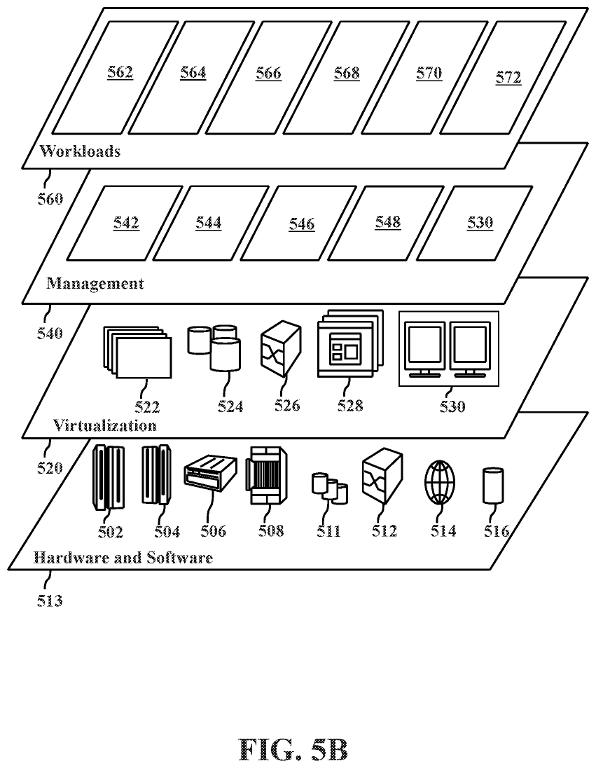

Referring now to FIG. 5A, illustrative cloud computing environment 510 is depicted. As shown, cloud computing environment 510 includes one or more cloud computing nodes 500 with which local computing devices used by cloud consumers, such as, for example, personal digital assistant (PDA) or cellular telephone 500A, desktop computer 500B, laptop computer 500C, and/or automobile computer system 500N may communicate. Nodes 500 may communicate with one another. They may be grouped (not shown) physically or virtually, in one or more networks, such as Private, Community, Public, or Hybrid clouds as described hereinabove, or a combination thereof. This allows cloud computing environment 510 to offer infrastructure, platforms and/or software as services for which a cloud consumer does not need to maintain resources on a local computing device. It is understood that the types of computing devices 500A-N shown in FIG. 5A are intended to be illustrative only and that computing nodes 500 and cloud computing 500 and cloud computing environment 510 can communicate with any type of computerized device over any type of network and/or network addressable connection (e.g., using a web browser).

Referring now to FIG. 5B, a set of functional abstraction layers provided by cloud computing environment 510 (FIG. 5A) is shown. It should be understood in advance that the components, layers, and functions shown in FIG. 5B are intended to be illustrative only and embodiments of the disclosure are not limited thereto. As depicted below, the following layers and corresponding functions are provided.

Hardware and software layer 515 includes hardware and software components. Examples of hardware components include: mainframes 502; RISC (Reduced Instruction Set Computer) architecture based servers 504; servers 506; blade servers 508; storage devices 511; and networks and networking components 512. In some embodiments, software components include network application server software 514 and database software 516.

Virtualization layer 520 provides an abstraction layer from which the following examples of virtual entities may be provided: virtual servers 522; virtual storage 524; virtual networks 526, including virtual private networks; virtual applications and operating systems 528; and virtual clients 530.

In one example, management layer 540 may provide the functions described below. Resource provisioning 542 provides dynamic procurement of computing resources and other resources that are utilized to perform tasks within the cloud computing environment. Metering and Pricing 554 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 546 provides access to the cloud computing environment for consumers and system administrators. Service level management 548 provides cloud computing resource allocation and management such that required service levels are met. Service Level Agreement (SLA) planning and fulfillment 550 provide pre-arrangement for, and procurement of, cloud computing resources for which a future requirement is anticipated in accordance with an SLA.

Workloads layer 560 provides examples of functionality for which the cloud computing environment may be utilized. Examples of workloads and functions which may be provided from this layer include: mapping and navigation 562; software development and lifecycle management 564; virtual classroom education delivery 566; data analytics processing 568; transaction processing 570; and journey ranking 572.

FIG. 4, illustrated is a high-level block diagram of an example computer system 501 that may be used in implementing one or more of the methods, tools, and modules, and any related functions, described herein (e.g., using one or more processor circuits or computer processors of the computer), in accordance with embodiments of the present invention. In some embodiments, the major components of the computer system 601 may comprise one or more Processor 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 628 and/or program modules 630 generally perform the functions or methodologies of various embodiments.

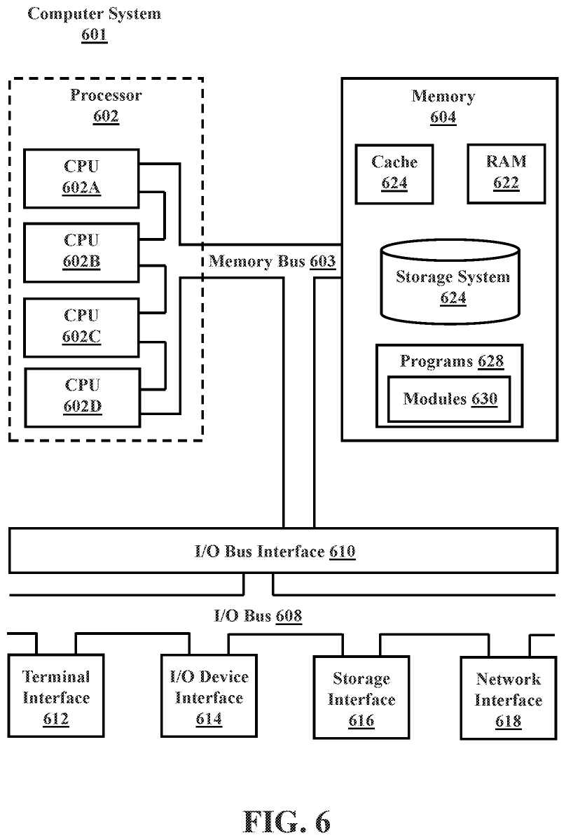

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smartphone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 4, components other than or in addition to those shown in FIG. 6 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, travel information and user travel query, wherein the user travel query is from a user;
analyzing the travel information and the user travel query;
generating one or more operational condition predictions from the travel information and user query;
generating one or more passenger satisfaction predictions from the travel information and user query;
identifying a user satisfaction score based, at least in part, on one or more feature variances; and
outputting the user satisfaction score.

2. The computer-implemented method of claim 1, wherein the one or more feature variances are based, at least in part on the one or more operational condition predictions and the one or more passenger satisfaction predictions.

3. The computer-implemented method of claim 2, further comprising:
determining the one or more feature variances, wherein the one or more feature variances is based on a configurable search parameter.

4. The computer-implemented method of claim 2, wherein the user satisfaction score is based on the one or more feature variances having a high probability level of occurrence.

5. The computer-implemented method of claim 2, wherein feature variances is selected from a group consisting of operational variances, external force variances, market forces variance, or a combination thereof.

6. The computer-implemented method of claim 1, further comprising:
generating a descriptive report, wherein in the descriptive report is associated with the user satisfaction score.

7. The computer-implemented method of claim 1, further comprising:
generating an aggregate expected user satisfaction score; and
generating a descriptive report, wherein the descriptive report includes the aggregate expected user satisfaction score.

8. A system, the system comprising:
a memory; and
a processor in communication with the memory, the processor being configured to perform operations comprising:
receiving travel information and user travel query, wherein the user travel query is from a user;
analyzing the travel information and the user travel query;
generating one or more operational condition predictions from the travel information and user query;
generating one or more passenger satisfaction predictions from the travel information and user query;
identifying a user satisfaction score based, at least in part, on one or more feature variances; and
outputting the user satisfaction score.

9. The system of claim 8, wherein the one or more feature variances are based, at least in part on the one or more operational condition predictions and the one or more passenger satisfaction predictions.

10. The system of claim 9, further comprising:
determining the one or more feature variances, wherein the one or more feature variances is based on a configurable search parameter.

11. The system of claim 9, wherein the user satisfaction score is based on the one or more feature variances having a high probability level of occurrence.

12. The system of claim 9, wherein feature variances is selected from a group consisting of operational variances, external force variances, market forces variance, or a combination thereof.

13. The system of claim 8, further comprising:
generating a descriptive report, wherein in the descriptive report is associated with the user satisfaction score.

14. The system of claim 8, further comprising:
generating an aggregate expected user satisfaction score; and
generating a descriptive report, wherein the descriptive report includes the aggregate expected user satisfaction score.

15. A computer program product, the computer program product comprising a computer readable storage medium having program instructions embodied therewith, the program instructions executable by a processor to cause the processors to perform a function, the function comprising:
receiving travel information and user travel query, wherein the user travel query is from a user;
analyzing the travel information and the user travel query;
generating one or more operational condition predictions from the travel information and user query;
generating one or more passenger satisfaction predictions from the travel information and user query;
identifying a user satisfaction score based, at least in part, on one or more feature variances; and
outputting the user satisfaction score.

16. The computer program product of claim 15, wherein the one or more feature variances are based, at least in part on the one or more operational condition predictions and the one or more passenger satisfaction predictions.

17. The computer program product of claim 16, further comprising:
determining the one or more feature variances, wherein the one or more feature variances is based on a configurable search parameter.

18. The computer program product of claim 16, wherein the user satisfaction score is based on the one or more feature variances having a high probability level of occurrence.

19. The computer program product of claim 16, wherein feature variances is selected from a group consisting of operational variances, external force variances, market forces variance, or a combination thereof.

20. The computer program product of claim 15, further comprising:
generating a descriptive report, wherein in the descriptive report is associated with the user satisfaction score.
